(19) United States
(12) Patent Application Publication
(10) Pub. No.: US 2007/0034165 A1
(43) Pub. Date: Feb. 15, 2007

(54) Pet collar

(76) Inventor: Tzu-Wen Yang, Rowland Heights, CA (US)

Correspondence Address: LAW OFFICES OF CLEMENT CHENG, 17220 NEWHOPE STREET #127, FOUNTAIN VALLEY, CA, 92708, US

(21) Appl. No.: 11/200,926

(22) Filed: Aug. 10, 2005

(51) Int. Cl. A62B 35/00

(52) U.S. Cl. 119/863

(57) ABSTRACT

The collar body is comprised of a plastic base strip and a rubbery outer layer that covers the base overall. The harder plastic base is partially exposed where fastening takes place to close the collar itself and at the pet ID tag formed integral to the collar body. A plurality of key holes are formed at both side arms of the body to fasten the free ends of the collar body the center of the body to an adjustable collar size. Located at both ends of the collar and facing toward each other are locking pins, which are extensions of the base. An engagement of both locking pins with the opposing keyholes establishes double locking of the collar ends in a handshaking relationship for added security of the collar.

### BACKGROUND OF THE INVENTION

A. Field of the Invention

The present invention relates to pet collars, and more particularly to a self-fastening pet collar combined with a pet ID tag without the conventional buckle member.

B. Description of the Prior Art

Pets such as dogs need restraints of collars and leads for their own safety and for the peace of mind of their owners. Resembling men's buckle belts, collars have been traditionally designed to have a flexible strap, a metal fastener attached to one end of the strap by stitching, punched holes at the other end of the strap to make a closing engagement with the fastener and another metal part of D-ring for attaching a leash, tags, etc. Good examples of such collars are found in U.S. Pat. Nos. 4,321,891 and 6,880,490.

Conventional nylon and leather materials in making these collar straps have inherent limitations in structuring and require a number of metal fixtures and fasteners to have the collar adjustably closed to the individual dog's sizes.

Because they have been categorized into the garment industry for manufacturing where labor is intensive, cost of making one and thus the retail prices have been unreasonably high. There is a need for an improvement in the collar design and material to cut the cost and time for mass-production.

### SUMMARY OF THE INVENTION

First of all, the pet collar of the present invention employs a rubberized plastic to provide a sturdy but flexible strip with an end-fastening means and a pet ID tag incorporated in the strip design. The dog collar of the present invention has a body generally in the shape of a strip. The collar body is comprised of a plastic base strip and a rubbery outer layer that covers the base all over. The harder plastic base may be partially exposed where fastening takes place to self-close the collar and at the pet ID tag formed integral to the collar body.

The base has one color while the outer layer has another, such as a neon or glow-in-the-dark color. This provides the color contrast between the outer layer and the exposed portions of the base to facilitate identifying the fastening means during collar adjustments by the owner.

The integral oval or round ID tag section is in the center of the body and has a central opening and an inner groove formed circumferentially in the inner diameter of the opening to receive a pet's tag.

To fasten the free ends of the collar body the center of the body to an adjustable collar size, a plurality of keyholes are formed at both side arms of the body. For example, keyholes of five can be formed in each of the arms of the body though its thickness. A keyhole is comprised of a round opening and an elongated slot extending from a section of the opening toward the distal ends of the body. Located at both ends of the collar and facing toward each other are locking pins, which are extensions of the base distally, terminating the collar. One of the locking pins is disposed near the distal end of the second arm facing inwardly while the other is near the distal end of the first arm facing outwardly. The locking pin is comprised of a shank having flat sides extending from the surface of the body perpendicularly and a round pinhead formed at the top of the shank. The pin head and the shank are sized so that the pin head may pass through the round opening at the opposing arm and when the shank is pushed into the slot the pin head is held on the body surface around the slot to lock the arm onto the other arm.

A separate ring member in the shape of numeral ‘8’ is prepared for slidably mounting on the collar and to receive an appropriate leash to be tied there. The ring may be cast from metal or aluminum. The ring member has a base wall, sidewalls extending upwardly from the base wall and a top wall joining the upper ends of the sidewalls. The front and rear edges of the sidewalls are tapered so that the base is wider than the top wall. A partition wall is formed to bridge the two side walls in the middle of the base and top walls defining a first opening for threading the collar and a second opening for tying an appropriate leash by the pet owner. Instead of the ring member as described, a conventional D-ring can be used instead.

Because the strip design contains the most needed in a dog collar, i.e. the soft outer layer texture, fastening means and even the dog tag an extremely simplified structure and streamlined look of a pet collar can be achieved by the present invention.

Accordingly, the general object of the present invention is to provide a plastic pet collar, which is durable but flexible to the extent that it incorporates a self-fastening means without the need of a buckle attachment.

Another object is to provide a pet collar with an integral pet ID tag, which adds no cost to manufacture.

### BRIEF DESCRIPTION OF THE DRAWINGS

FIG. 1 is a perspective view of the pet collar of the present invention.

FIG. 2 is a cross sectional view of the pet collar drawn along line 2-2- of FIG. 1.

FIG. 3 is a perspective view of the leash ring for the pet collar of FIG. 1.

Embodiments of the invention will now be described by way of example with reference to the accompanying drawings.

### DETAILED DESCRIPTION OF THE PREFERRED EMBODIMENT

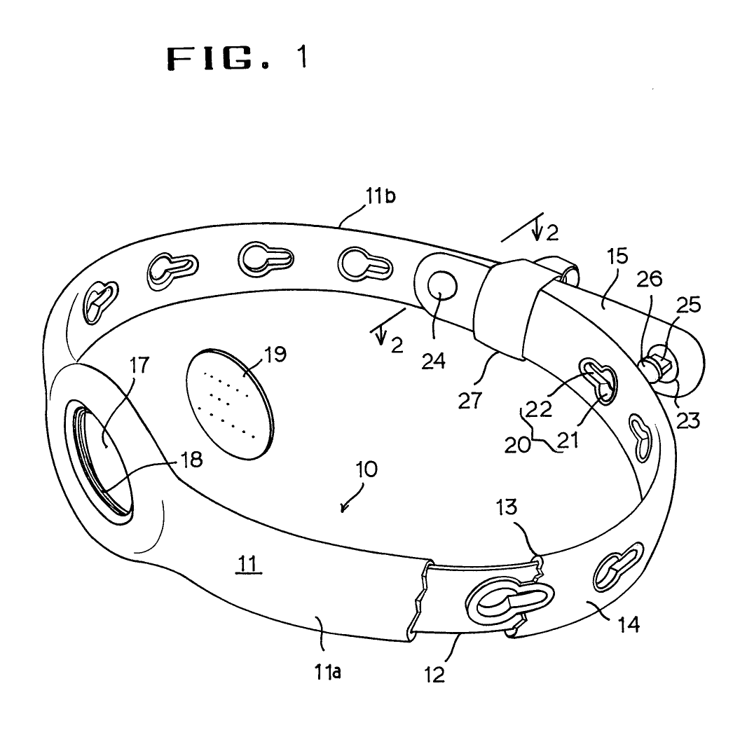

Referring to FIG. 1, the dog collar 10 of the present invention has a strip like body 11. The collar body 11 is generally comprised of a plastic base 12 and a rubbery outer layer 13. The body 11 has a first surface 14 facing outward of the closed collar 10 and a second surface 15 facing opposite to the first surface 14, i.e. inward. FIG. 1 shows a cut away view of base 12 beneath the surfaces 15, 14.

The outer layer 13 constitutes a soft cover over the base 12 except selected areas exposed where more hardness is desirable. Preferably, the base 12 has one color while the outer layer 13 has another, such as a neon or glow-in-the-dark color. This two tone color scheme gives the color contrast between the outer layer 13 and the exposed portions of the base 12 that is beneficial in connection with using fastening means as will be explained in detail below. The soft layer preferably of thermoplastic rubber can also be semi transparent allowing a user to see the base strip preferably made of polypropylene. A reflective base strip can provide nighttime safety when the outside layer is transparent.

At the center of the body 11 is formed an oval or round ID tag section 16 having an enlarged central opening 17 and an inner groove 18 formed circumferentially in the inner diameter of the opening 17. Outer layer 13 may cover the body 11 short of the opening 17 to expose the groove 18. In the groove 18, the pet owner can insert a tag 19 with written information on the pet. The tag can also be lighted with LED or enabled with a transponder such as a GPS receiver or fashion designs such as jewelry. The tag can also operate as a dog training device module.

Equidistantly along the longitudinal axis of the body 11, a plurality of keyholes 20 is formed at both sides of the opening 17. The first side of the body 11 is designated as a first arm 11a and its second side a second arm 11b. Specifically, the present embodiment has five of such keyholes 20 at each arm 11a or 11b of the body 11 through its thickness. About the keyholes 20 the base 12 has an added thickness T up to which the soft material of outer layer 13 covers to provide a generally even and smooth surfaces all over the collar. Keyhole 20 is comprised of a round opening 21 and an elongated slot 22 extending from a section of the opening 21 toward the distal ends of the body 11.

Because the keyholes 20 are contrasted by color with the surrounding outer layer 13 it is easy for the pet owner to identify them in collar adjustments. Located at both ends of the collar 10 but facing the opposite sides of the body 11 are locking pins 23 and 24. Locking pins 23 and 24 are protruded from the base 12 at its both distal ends.

Because of the opposite engaging keyhole configuration, tension on the collar will tighten the locking grip. Locking pin 23 is disposed near the distal end of the second surface 15 of the second arm 11b facing inwardly while the pin 24 is near the distal end of the first surface 14 of the first arm 11a facing outwardly. Referring further to FIG. 2, locking pin 24 is comprised of a shank 25 having flat sides extending from the surface of the body 11 perpendicularly and a round pinhead 26 formed at the top of the shank 25. The pin head 26 and the shank 25 are sized so that the pin head 26 may pass through the round opening 21 at the opposing arm 11 a and when the shank 25 is pushed into the slot 22 the pin head 26 is held on the body surface around the slot 22 to lock the arm 11b onto the other arm 11a.

The same applies to the locking pin 24. The outwardly facing pin 24 has the same configuration as the pin 23 except that it is located at the first arm 11a and faces opposite to the pin 23 to allow the two arms 11a and 11b to be in a handshaking relationship to each other. This double locking secures the fastening of the collar ends against pushing and pushing through the leash in use. The position of the locking pins 23 and 24 were contemplated to prevent the collar ends from catching pet hair or other objects that might result in an accidental opening of the collar and an unwanted release of the pet.

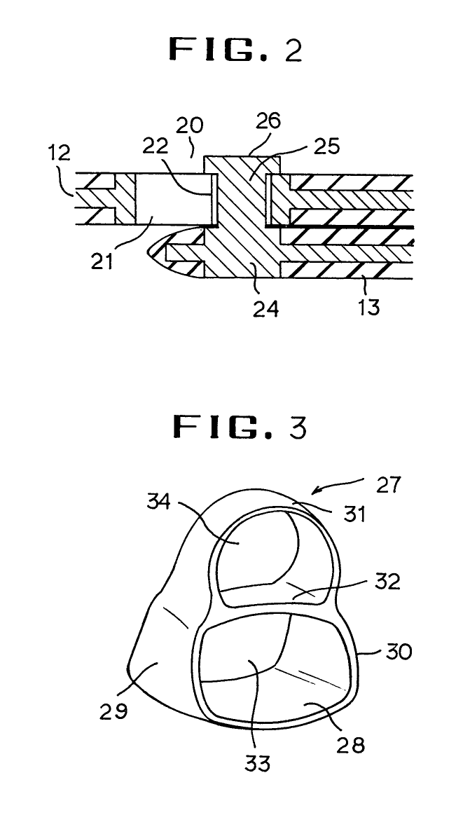

A separate ring member 27 is prepared for tethering an appropriate leash for the individual pet. The embodiment as in FIG. 3 shows a double ring cast in a single piece although a conventional D-ring can be used instead. The ring member 27 has a base wall 28, side walls 29 and 30 extending upwardly from the wall 29 and a top wall 31 joining the upper ends of the side walls 29 and 30. The front and rear edges of the sidewalls 29 and 30 are tapered so that the base 28 is wider than the top wall 31. A partition wall 32 is formed to bridge the two side walls 29 and 30 in the middle of the base and top walls 28 and 31 and 28 defining an opening 33 for threading the collar 10 and an eyelet 34 for tying an appropriate leash by the pet owner. The outside layer commonly made of thermo plastic rubber allows friction between the ring and the collar so that the ring does not move relative to the collar while in use. The outside surface can be made of antibacterial surface. Optionally, the outside surface can also receive fragrance. Decorative elements can be injected into the outside surface layer such as glitter, which would be suspended inside the thermal plastic rubber.

The present invention contemplates that many changes and modifications may be made. Therefore, while the presently preferred form of the pet collar has been shown and described, and several modifications thereof discussed, persons skilled in this art will readily appreciate that various additional changes and modifications may be made without departing from the spirit of the invention, as defined and differentiated by the following claims.

1. A pet collar comprising:
a. a flexible but hard base strip having an enlarged central opening for a pet ID tag and a first and second fastening arm at each side of the central opening that can be fastened to each other to close the hard base strip to an adjustable diameter, wherein each of the fastening arms include a distal protrusion from either one of the opposite planes of the base strip and a predetermined number of through key holes formed on the base strip;
b. a soft layer rubbery and molded over the hard base strip in a predetermined thickness extending over the base strip leaving selected areas clear where more hardness of the base strip is desired including the tag opening, distal protrusion and key holes; and
c. a ring member threaded on the collar to provide an eyelet for tying a pet leash.

2. The pet collar of claim 1, wherein the tag is lighted with LED.

3. The pet collar of claim 1, wherein the tag is enabled with a transponder such as a GPS receiver.

4. The pet collar set forth in claim 1, wherein the protrusion is in the shape of a pin head with a shank extending from the base strip perpendicularly and the key holes have a matching round opening to receive the pin head and shank and a narrow slot extending from the round opening to engage the pin head, whereby the pin heads at both the arms may lock into the key holes at their opposing arms at the same time to secure the closure of the collar under pushing and pulling through the leash.

5. The pet collar set forth in claim 1, wherein the ring member is a double ring cast in a piece having a base wall, side walls extending upwardly from the base wall and merging at their upper ends into a top wall, and a partition wall positioned between the base and top walls bridging the side walls to define a space to hold the collar and an eyelet for tying the leash.

6. The pet collar set forth in claim 1, wherein the base strip has one color while the outer layer has another to provide a color contrast therebetween for an easy identification of the fastening member of the protrusions and key holes in adjustments of the collar diameter by the pet owner.

7. The pet collar set forth in claim 6, wherein the outer layer has a neon or glow-in-the-dark color to add a safety factor for the pet.

8. A pet collar comprising:
a. a base strip having tag holder between first and second arms at each side of the tag holder that can be fastened to each other to close the base strip to an adjustable diameter, at least one of the fastening arms including a distal protrusion engagable with a key hole formed on the base strip.
b. a soft outer layer rubbery and molded over the hard base strip extending over the base strip leaving selected areas clear where more hardness of the base strip is desired including the tag opening, distal protrusion and key holes.

9. The pet collar set forth in claim 8, wherein the protrusion is in the shape of a pin head with a shank extending from the base strip perpendicularly and the key holes have a matching round opening to receive the pin head and shank and a narrow slot extending from the round opening to engage the pin head, whereby the pin heads at both the arms may lock into the key holes at their opposing arms at the same time to secure the closure of the collar under pushing and pulling through the leash.

10. The pet collar set forth in claim 8, further comprising a ring member, wherein the ring member is a double ring cast in a piece having a base wall, side walls extending upwardly from the base wall and merging at their upper ends into a top wall, and a partition wall positioned between the base and top walls bridging the side walls to define a space to hold the collar and an eyelet for tying the leash.

11. A pet collar comprising:
a. a base strip having first and second arms at each side that can be fastened to each other to close the base strip to an adjustable diameter, at least one of the fastening arms including a distal protrusion engagable with a key hole formed on the base strip.
b. a soft outer layer molded over the hard base strip extending over the base strip leaving selected areas clear where more hardness of the base strip is desired including the tag opening, distal protrusion and key holes.

12. The pet collar set forth in claim 11, wherein the protrusion is in the shape of a pin head with a shank extending from the base strip perpendicularly and the key holes have a matching round opening to receive the pin head and shank and a narrow slot extending from the round opening to engage the pin head, whereby the pin heads at both the arms may lock into the key holes at their opposing arms at the same time to secure the closure of the collar under pushing and pulling through the leash.

13. The pet collar set forth in claim 11, further comprising a ring member, wherein the ring member is a double ring cast in a piece having a base wall, side walls extending upwardly from the base wall and merging at their upper ends into a top wall, and a partition wall positioned between the base and top walls bridging the side walls to define a space to hold the collar and an eyelet for tying the leash.

14. The pet collar set forth in claim 11, wherein the base strip has one color while the outer layer has another to provide a color contrast therebetween for an easy identification of the fastening member of the protrusions and key holes in adjustments of the collar diameter by the pet owner.

15. The pet collar set forth in claim 11, wherein the outer layer has a neon or glow-in-the-dark color to add a safety factor for the pet.

16. The pet collar set forth in claim 11, wherein the base strip has a color while the outer layer has transparency.

17. The pet collar set forth in claim 11, wherein the base strip is reflective and can provide nighttime safety wherein the outside layer is transparent.

18. The pet collar set forth in claim 11, wherein tension on the collar will tighten the locking grip.
